(19) United States
(12) Patent Application Publication
(10) Pub. No.: US 2011/0250569 A1
(43) Pub. Date: Oct. 13, 2011

(54) Digital Avionics Simulator

(76) Inventor: Sidney Allen Connor, Laurel, MD (US)

(21) Appl. No.: 12/957,386

(22) Filed: Nov. 30, 2010

Related U.S. Application Data
(60) Provisional application No. 61/265,362, filed on Dec. 1, 2009.

(51) Int. Cl. G09B 9/08

(52) U.S. Cl. 434/30

(57) ABSTRACT

A method for simulating and testing avionics in a low cost PC-based flight simulator, including: converting simulator data into standard avionics messages; transmitting the avionics messages to other devices linked to the avionics simulator; receiving avionics messages and converting them to simulator data elements; and writing the simulator data elements into a flight simulators data parameters.

This application claims priority to U.S. provisional patent application No. 61/265,362, which is incorporated herein for all purposes.

### BACKGROUND OF THE INVENTION

The present invention relates systems for testing avionics.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating an embodiment of the present invention;

FIG. 2 is a block diagram illustrating another embodiment of the present invention;

FIG. 3 is a block diagram illustrating another embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

This invention is a system that may be implemented using a software module “add-on” or “plug-in” that operates with a PC based flight simulator or other vehicle simulator to transmit and/or receive industry standard or government standard digital avionics messages. The invention is referred to as a Digital Avionics Simulator (DAS).

This invention improves existing desktop simulators by giving them the ability to receive and transmit standard avionics messages. This capability has several applications including:
1) Simulated flight testing of new avionics equipment,
2) Simulator development using real avionics equipment, and
3) Simulated flight training using real avionics equipment.

The DAS was originally conceived to significantly reduce the high cost of avionics development and flight test certification of various types of avionics equipment such as, for example, Head-Up Displays (HUD). Development and certification of new avionics equipment is very expensive owing largely to the high cost of aircraft flight testing. Large scale simulators and Integration Test Facilities (ITF's) that interface with real avionics equipment are also extremely expensive to build, maintain, and operate. In addition, large scale simulators and ITF's also tend to be inflexibly fixed to a specific aircraft type.

The advent of low-cost PC based flight simulators, with highly accurate physics models makes it possible to achieve a level of realistic performance with a PC that is competitive with large scale simulators and ITF's at a significantly reduced cost. However, these PC-based simulators do not natively integrate with or communicate with real avionics equipment. This limitation severely restricts the ability to build realistic simulators with real avionics equipment. The DAS solves that problem. With the DAS, real avionics equipment can be integrated with PC based simulators. Because of this, the DAS makes it possible to perform simulated flight tests on new avionics equipment and to build low-cost realistic simulators and ITF's that integrate with real avionics equipment for training purposes.

The economic value of using the DAS to perform simulated flight testing of new avionics equipment is easily seen when one considers the cost per hour to perform actual flight testing on a single target aircraft platform. The cost per hour to operate the real aircraft or large scale simulators or ITF's is generally on the order of thousands of dollars. The cost per hour to operate a PC-based simulator with the DAS is orders of magnitude cheaper by comparison.

When flight testing a new piece of avionics equipment requires hundreds of hours to complete, large scale simulator and flight test operations costs will be in the hundreds of thousands of dollars. In addition, a typical air transport company could lose a hundred thousand dollars (or more) per day that an aircraft is out of revenue service for flight testing a new piece of avionics equipment. These costs can amount to millions of dollars of total revenue losses for taking an aircraft taken out of service for months to flight test and certify a new piece of avionics equipment. The DAS can significantly reduce these losses by making it possible to perform realistic simulated flight tests to resolve interface and functionality problems with the new avionics equipment before it is ever installed in an aircraft. In situations where it is desirable to certify the new avionics on multiple aircraft types, the cost advantages of using the DAS are multiplied by the number of aircraft types.

The safety benefits of using the DAS for avionics testing prior to flight test in a real aircraft are also important. Using the DAS, simulated flight tests of avionics equipment can be conducted in the safety of the laboratory over a wide range of environmental conditions and throughout the full range of modes and maneuvers. The DAS also permits failure testing in extreme conditions that would not normally be possible in the real aircraft.

The DAS also has training benefits. First, it enables the manufacture of low cost realistic simulators that are integrated with real avionics equipment. Second, this cost advantage can make the use of these realistic simulators more accessible and affordable for pilots, aircraft manufacturers, avionics companies, aviation companies, air transport companies, flight training schools, and government agencies. Third, the use of real avionics with the DAS has the potential to increase the transfer of training to the real world environment.

The DAS also has marketing advantages. Because it is PC based, it can be easily transported and configured for demonstrations at trade shows or conference rooms. In addition, because it can be configured for a wide variety of aircraft and avionics systems, the DAS can be used to demonstrate the functionality of a new piece of avionics equipment to prospective customers for their specific aircraft and avionics configurations.

In summary, the DAS makes it possible to test, certify, train, and market new or existing avionics equipment on a wide range of aircraft and avionics systems at a greatly reduced cost to manufacturers, vendors, and end users of the equipment.

The Digital Avionics Simulator (DAS) may be implemented as a software plug-in or add-on to a PC based flight simulator or ground vehicle simulator that extends the functionality of the PC based simulator to convert internal data parameters into industry standard or government standard avionics messages and transmit these avionics messages through an avionics interface device such as a PCI card, PCMCIA card, PCMCIA Express Card, USB or other industry standard interface. The avionics standard messages that the DAS can work with include but are not limited to:
1) ARINC-429,
2) ARINC-664 (AFDX),
3) ARINC-708,
4) ARINC-717,
5) CSDB,
6) Discrete,
7) ARINC 629,
8) ASCB, and
9) MIL-STD-1553.

The DAS also has the ability to work with a variety of different avionics interface devices made by a variety of different manufacturers. For example, the DAS can work with ARINC-429 PCI or PCMCIA interface cards or MIL-STD-1553 interface cards as well as USB interface boxes and many other avionics interface devices. In most cases, it interacts with the interface device through device drivers and an Application Programming Interface (API) that is generally provided by the avionics interface device manufacturer.

After being loaded, the DAS software can “program” or configure the avionics interface device to transmit and/or receive avionics messages. After configuring the interface device, the DAS plug-in is periodically called by the PC based simulator to perform its functions. The frequency of the calls to the DAS could be as often as once every processing loop or less frequently.

The transmit portion of the DAS functions by converting the internal data parameters of the simulator into the desired avionics message format each time the DAS is called by the simulator. The converted avionics messages are then passed through an application programming interface (API) to the avionics interface device. The avionics interface device then transmits the avionics messages at the appropriate schedule for the message.

The receive portion of the DAS reads avionics messages that have been received by the avionics interface device from an external source. These messages are converted into parameters and units used by the simulator. Additional transformations of the data can be made as well as calculations for other parameters. The DAS then uses the simulator API to set the appropriate data parameters in the simulator. In some instances, such as those involving position and attitude data parameters, the DAS will need to override the physics engine of the simulator.

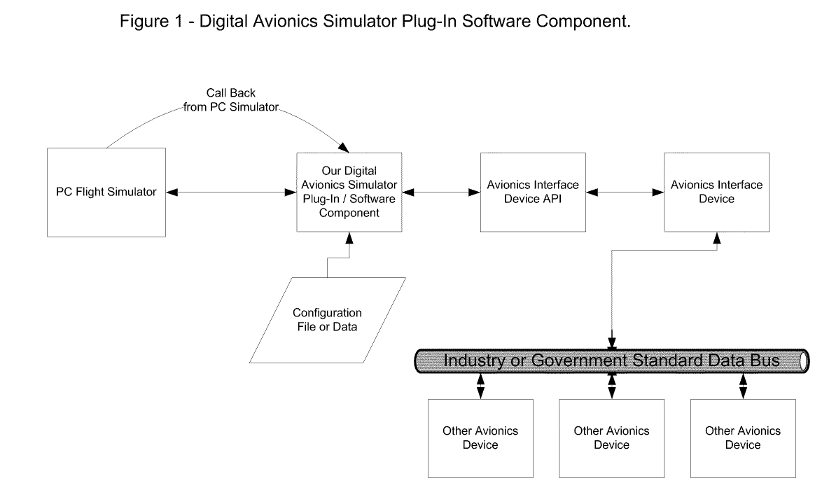

According to FIG. 1, our Digital Avionics Simulator Plug-in gets data from the PC Flight Simulator and converts it into Industry or Government Standard Avionics Data and transmits it to other avionics devices using an Avionics Interface Device such as a MIL-STD-1553 PC card or ARINC-429 USB device. Our Digital Avionics Simulator Plug-in can also receive data from external devices and convert that data back into PC Flight Simulator data parameters for controlling the PC Flight Simulator. Our Digital Avionics Simulator Plug-in communicates with the Flight Simulator and with the Avionics Interface Device using a vendor provided or other standard API function calls. Our Digital Avionics Simulator Plug-in can be configured to handle different data transmission schedules, different parameters, different data formats, etc., using a Configuration File or Database or Data that is compiled into the Digital Avionics Simulator Plug-in. Our Digital Avionics Simulator Plug-In makes it possible to interface existing PC based flight simulators with real avionics equipment for training, testing, certification, etc. Our Digital Avionics Simulator Plug-in makes it possible to perform hardware in the loop testing with low cost PC based flight simulators instead of requiring the use of high cost flight simulators and integration test facilities that are currently used in the industry.

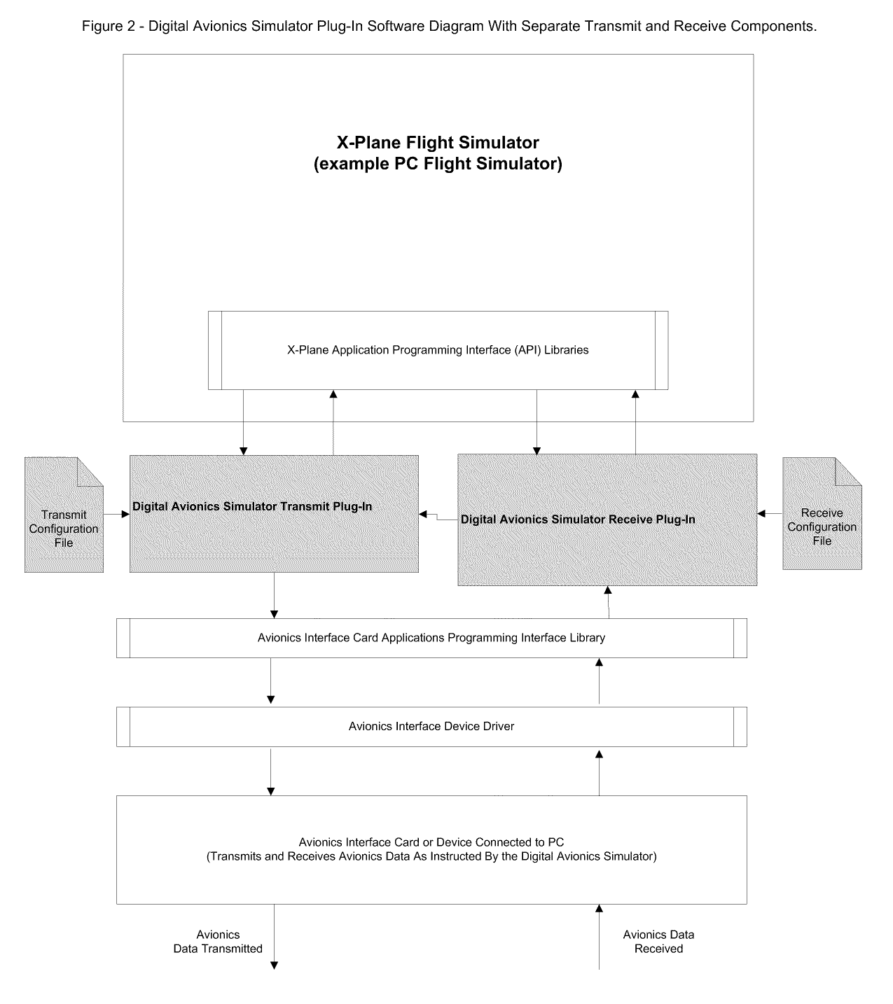

According to FIG. 2, the Digital Avionics Simulator Transmit Plug-In does the following:
1. Captures Simulator Data
2. Gets Data Characteristics from the Transmit Configuration File
3. Gets Transmit Rules from Transmit Adapter File
4. Converts Simulator Data to Avionics Messages
5. Outputs Avionics Messages to Avionics Interface Card
6. Programs the Avionics Interface Card

Further, the Digital Avionics Simulator Receive Plug-In does the following:
1. Gets Data Characteristics from Receive Configuration File
2. Gets Receive/Transmit Response Rules from Receive Configuration File
3. Captures Avionics Data from Interface Card
4. Converts Avionics Data to Simulator Data
5. Updates Simulator Parameters with Avionics Data
6. Sends the Transmit Plug-In Transmit Commands

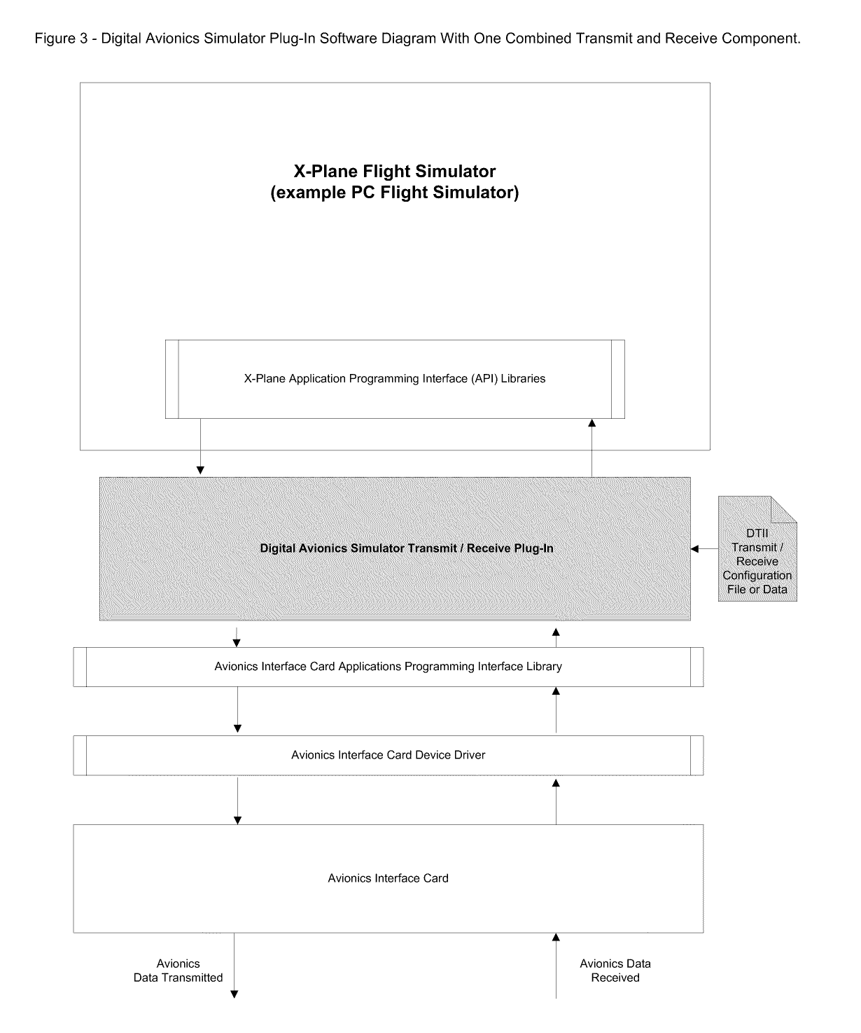

According to FIG. 3, the Digital Avionics Simulator Transmit/Receive Plug-In does the following:
1. Gets Data Characteristics from Receive Configuration File
2. Gets Receive/Transmit Response Rules from Receive Configuration File
3. Captures Avionics Data from Interface Card
4. Converts Avionics Data to Simulator Data
5. Updates Simulator Parameters with Avionics Data
6. Sends Transmit Plug-In Transmit Commands

What is claimed is:

1. A method for simulating and testing avionics using a low cost PC based flight simulator, comprising:
converting simulator data into standard avionics messages;
transmitting the avionics messages to other devices linked to the avionics simulator;
receiving avionics messages and converting them to simulator data elements; and
writing the simulator data elements into a flight simulator's data parameters.
